(19) United States
(12) Patent Application Publication
(10) Pub. No.: US 2016/0096234 A1
(43) Pub. Date: Apr. 7, 2016

(54) LASER DEPOSITION AND REPAIR OF REACTIVE METALS

(71) Applicant: SIEMENS ENERGY, INC., Orlando, FL (US)

(72) Inventors: Gerald J. Bruck, Oviedo, FL (US); Ahmed Kamel, Orlando, FL (US)

(21) Appl. No.: 14/508,144

(22) Filed: Oct. 7, 2014

(51) Int. Cl. B23K 26/34; B23K 26/12; B23K 35/32; B23K 35/36; B23K 35/28

(52) U.S. Cl. CPC B23K 26/34; B23K 35/3602; B23K 35/3605; B23K 35/3603; B23K 35/284; B23K 35/286; B23K 35/325; B23K 35/32; B23K 26/125

(57) ABSTRACT

Laser processing of reactive metals. One repair process involves laser melting a titanium alloy filler material (4) in the presence of a flux composition (8) to form a titanium alloy cladding (14) bonded to a surface of a titanium-containing component (2). A laser beam (10) may be applied to a flux composition (8) covering a powdered filler material (4) such that the laser beam simultaneously melts the flux composition and the powdered filler material to form a melt pool (12) which solidifies into a resulting alloy layer (14) covered by a slag layer (16). A laser beam (20) may heat a flux composition (8) such that an amount of energy applied to the flux composition is controlled so that a molten slag blanket (24) heats and melts a powdered filler material (4) by thermal conduction in the presence of a shielding gas (26).

### FIELD OF THE INVENTION

This application relates to materials technology in general and more specifically to laser processing and repair of highly reactive metals such as titanium alloys.

### BACKGROUND OF THE INVENTION

Reactive metals including titanium alloys are used to manufacture turbine blades and other components of modern steam turbines and gas turbines. Due to the unique physical, mechanical, chemical and electrical properties of titanium, the manufacture and repair of large-sized titanium components has been limited to arc welding processes such as submerged arc welding (SAW) and electroslag welding (ESW). Although more precise techniques such as laser welding have been applied to address the more stringent requirements for repair of complex titanium parts, these techniques are generally conducted under an inert gas atmosphere and often within an inert gas or vacuum chamber. Consequently, such techniques are generally not available to accomplish the manufacture and/or repair of larger objects containing intricate features.

Large-scale welding of reactive alloys is especially challenging due to the affinity of reactive metals in a molten state to react with oxidizing agents and other atmospheric compounds that are difficult to exclude from the work area. For example, titanium reacts with atmospheric constituents like oxygen, hydrogen and nitrogen to form impurities such as titanium oxides and nitrides (often in the form of inclusions) that can degrade mechanical properties and, e.g., reduce the toughness and ductility of the resulting alloys. Titanium metals and alloys are also prone to excessive grain growth at high temperatures, which is also detrimental to toughness. In contrast to steels, with titanium metals and alloys there is often no alternative for refining grain size through post-weld heat treatments. Furthermore, the complexity of the resulting phase transformations often renders the behavior of titanium-containing welds unpredictable.

Based upon the above considerations, it is known to reduce the formation of these chemical and mechanical imperfections by welding reactive metals in closed chambers filled with inert gases or by using specialized process location and trailing shields designed for particular welding applications. It is also known to reduce such imperfections by lowering the welding energy; but this often reduces the attainable weld thickness.

The use of flux agents to reduce the formation of chemical impurities, by limiting exposure of molten reactive metals to atmospheric reactants, has also been previously attempted. In large-scale ESW applications, for example, it is known to employ ionic fluxing agents such as calcium fluoride (CaF₂) to improve the welding of relatively thick (25 mm and 50 mm) titanium alloy plates. See Devletian et al., “Fundamental Aspects of Electroslag Welding of Titanium Alloys,” Recent Trends in Welding Science and Technology, ASM 1990. Flux materials have also been explored to enhance weld penetration during tungsten inert gas (TIG) joining of titanium alloys. See Liu et al., “A-TIG Welding of CP Titanium Plates Using Cryolite-Containing Flux Pastes and Flux-Cored Wires,” Corrosion Solutions Conference 2009, Paper 4A2, pp. 211-20.

### BRIEF DESCRIPTION OF THE DRAWINGS

The invention is explained in the following description in view of the drawings that show:

FIG. 1 illustrates a laser melting process of the present disclosure; and

FIG. 2 illustrates an alternative laser melting process of the present disclosure.

### DETAILED DESCRIPTION OF THE INVENTION

The present Inventors have recognized that a need exists to discover methods and materials for manufacturing and repairing large components constructed of reactive metals that tend to form chemical and/or mechanical imperfections when welded under atmospheric conditions. Ideal methods and materials would enable the repair and manufacture of various reactive-metal components (both large and small sized) without forming unwanted chemical imperfections (e.g., inclusions of oxides, nitrides, etc.), cracking and/or excessive grain growth as described above—while at the same time avoiding the need to employ rigorously air-free conditions requiring, for example, the use of inert gases or enclosed processing chambers. Ideal methods and materials would also enable the manufacture and repair of reactive-metal components containing intricate structural features that cannot be fabricated using typical large-scale processes such as submerged arc welding (SAW) and electroslag welding (ESW).

The term “reactive metals” is used herein in a general sense to describe metals and alloys of elements such as aluminum, magnesium, titanium and zirconium, which readily react in molten form with reactive constituents in air such as oxygen, nitrogen and hydrogen. Molten titanium, for instance, reacts very quickly with molecular oxygen to form titanium oxide (TiO₂) which, when dispersed within a resulting alloy, tends to reduce toughness and ductility. The term “metal” is used herein in a general sense to describe pure metals as well as alloys of metals.

Disclosed herein are novel methods and materials which can accomplish the above goals by using laser powder deposition in the presence of flux materials that are tailored to reduce or eliminate the formation of unwanted chemical and mechanical imperfections. Whereas flux materials commonly used for reactive metals (such as titanium) are often formulated to accommodate the electrical requirements of arc welding, the flux materials employed herein for laser powder deposition are not limited to compounds necessary to enhance arc stability or electrical conductivity. Use of laser heating instead of arc heating therefore greatly expands the range of possible flux materials allowing, among other things, greater control of heating than was previously possible. An ability to modulate the intensity and mode of heating of a filler material by controlling the laser heating, as well as the absorptivity and thermal characteristics of the flux material, is expected to enable the repair of large-sized, reactive-metal-containing components without the need to employ the rigorously air-free conditions that are typically required.

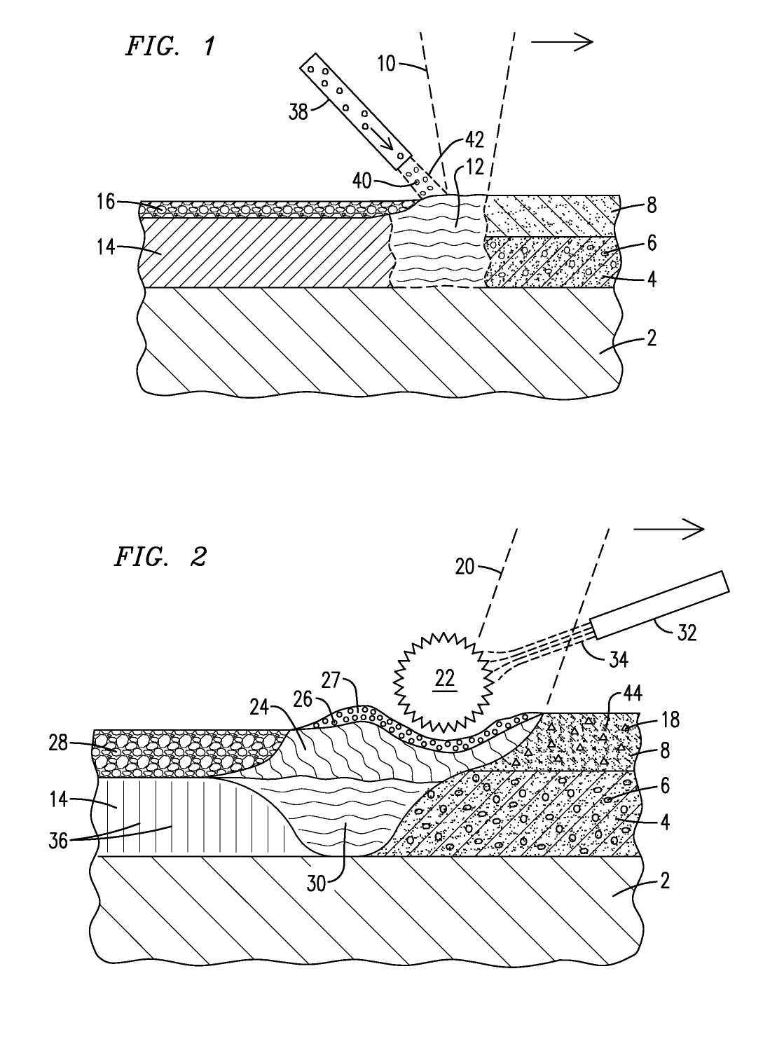

FIG. 1 illustrates one embodiment of the present disclosure wherein a powdered filler material 4 containing a titanium alloy 6 is pre-placed or fed onto a surface of a support material 2, and is then covered (by pre-placement or feeding) with a flux composition 8 which is formulated for laser heating. Alternatively, the flux and powdered metal may be mixed together and pre-placed or fed over the substrate. Still alternatively, the flux and metal may be prepared in the form of conglomerate particulate containing both flux and metal and pre-placed or fed over the substrate.

Alternatively, the filler material 4 and/or the flux composition 8 may be contained within a preform structure having at least one compartment enabling greater control in the placement and deposition of the contained material. In one such embodiment, for example, the filler material 4 is contained within a lower compartment and the flux composition 8 is contained within an upper compartment, said compartments being attached together to form an integral preform structure. The reactive metal of such a preform may be constrained in a distribution that defines a shape of a layer or slice of a component subject to repair or additive fabrication. The compartments of such preforms are generally constructed of walls and a sealed periphery, in which the walls may be sheets of any type (such as fabric, film, or foil that retains the contents) and the periphery may include a non-metallic, non-melting, laser blocking material (such as graphite or zirconia).

In the embodiment of FIG. 1, laser powder deposition occurs by traversing a laser beam 10 across the surface of the flux composition 8 to melt both the flux composition 8 and the underlying filler material 4 to form a melt pool 12. The melt pool 12 then undergoes cooling to form a deposited alloy layer 14 covered by a slag layer 16.

As explained below in greater detail, the penetration of laser energy and to a certain extent the mode of heat transfer to the filler material 4 may be controlled in part by altering the formulation and/or physical characteristics of the flux composition 8. FIG. 1 illustrates a non-limiting embodiment in which the laser beam 10 undergoes deep penetration to simultaneously heat and melt both the flux composition 8 and the filler material 4. Such direct radiant heating of the filler material 4 can be important in some embodiments involving deposition of a reactive metal alloy having a relatively high melting point. Deep penetration may also be important for embodiments in which the deposited alloy layer 14 needs to be firmly bonded to the underlying support material 2, such as repair processes involving cladding of superalloy materials or other high-temperature alloys. In such cladding applications involving bonding to the support material 2, deep penetration may be necessary to affect partial melting of the surface of the support material 2.

In some embodiments the flux composition 8 and/or the filler material 4 and/or a preform structure may contain a shielding agent capable of generating at least one gaseous substance in order to displace reactive gases, such as oxygen and nitrogen, when heated by the laser beam 10. Such gaseous substances can include volatile compounds such as hydrogen, carbon monoxide and carbon dioxide. Other embodiments exclude such shielding agents due to the potential affinity of certain reactive metals to react with molecular gases such as carbon monoxide and carbon dioxide.

FIG. 2 illustrates another embodiment wherein the flux composition 8 is formulated to reduce penetration of laser heating, such that melting of the filler material 4 occurs to some degree using indirect heating. The flux composition can, for instance, be formulated to contain a plasma-generating agent 44 which reacts upon exposure to the laser beam 20 to form a plasma 22. Such a plasma 22 can reduce radiant heating by absorbing a portion of the laser beam 20. The plasma 22 can then indirectly heat the flux composition 8 through various modes of heat transfer (radiation, conduction and convection) to affect greater control over heat applied to both the flux composition 8 and the filler material 4.

In the embodiment of FIG. 2 the controlled heating causes the flux composition 8 to form a molten slag blanket 24 over the filler material 4. Heat from the molten slag blanket 24 may then travel into the filler material 4 by conduction to produce a slower melting rate (relative to FIG. 1) of the reactive metal 6 to form a separate filler melt pool 30. In this manner it may be possible in some instances to greatly reduce the amount of superheating of the filler melt pool 30—thus reducing the affinity of the reactive metal 6 to react with residual gases such as oxygen and nitrogen. Such lowering of the temperature of the filler melt pool 30 may also allow for the presence of shielding gases 26 (e.g., CO, CO₂, H₂) produced from a shielding agent 18 contained in the flux composition 8.

As explained above, the presence of shielding gases can improve the chemical and mechanical characteristics of the deposited alloy layer 14 by displacing atmospheric oxygen and nitrogen to reduce the formation of oxides and nitrides. Shielding gases can also contribute in some embodiments to an ability to conduct processes of the present disclosure under an oxygen-containing atmosphere. As shown in FIG. 2, the shielding gases 26 can coalesce to form a volume of gas 27 covering the molten slag blanket 24.

The molten slag blanket 24 and the filler melt pool 30 are then allowed to cool and solidify into a solid slag layer 28 which covers a deposited alloy layer 14.

Control of heating is possible by varying a number of factors. First, the amount of radiant heating can be modulated by controlling the frequency and intensity of the laser beam. Reducing the laser intensity causes a corresponding reduction in radiant heating to both the flux composition 8 and the filler material 4. Various methods are available for modulating laser intensity including the use of a pulsed laser beam. Altering the frequency can also affect radiant heating of the flux and/or filler, based on the absorption characteristics of the respective materials. It is known that different materials have different absorption characteristics—such that a material which readily absorbs a “green” Nd:YAG laser beam (λ=503 nm) may be transparent or reflective to a CO₂ laser beam (λ=10.6 μm). Thus, selective absorption and heating may be possible in some embodiments based on, for example, the choice of a “green” Nd:YAG laser beam (λ=503 nm) or a Nd:YAG laser (λ=1.06 μm) or a CO₂ laser beam (λ=10.6 μm).

A second factor relates to the content and form of the flux composition 8. As explained above the use of laser heating (as opposed to arc heating) provides greater versatility in the choice of flux materials. Consequently, in some embodiments the flux composition 8 may be formulated to contain certain materials (or higher proportions thereof) which absorb laser radiation at the appropriate frequency, in order to increase indirect (conductive) heating of the filler material 4 by the molten slag blanket 24. In other embodiments the flux composition 8 may be formulated to contain certain materials (or proportions thereof) which transmit laser radiation in order to increase direct (radiant) heating of the filler material 4—thus increasing penetration of the laser beam 10,20.

The form of the flux composition 8 can also effect laser absorption by altering its thickness and/or particle size. As the thickness of the layer of the flux composition 8 increases, the absorption of laser heating generally increases. Increasing the thickness of the flux composition 8 also increases the thickness of the resulting molten slag blanket 24, which further enhances absorption of the laser beam 20. Thus, increasing the thickness of the layer of the flux composition 8 may reduce direct (radiant) heating of the filler material 4 and the filler melt pool 30. The thickness of the layer of the flux composition 8 in methods of the present disclosure typically ranges from about 3 mm to about 25 mm. In some cases the thickness ranges from about 5 mm to about 20 mm, while in other instances the thickness ranges from about 7 mm to about 15 mm.

Reducing the average particle size of the flux composition 8 also causes a corresponding increase in laser energy absorption (presumably through increased photon scattering within the bed of fine particles and increased photon absorption via interaction with increased total particulate surface area thereby increasing the amount of direct (radiant) heating of the filler material 4 by the laser beam. In terms of the particle size, whereas commercial fluxes generally range in average particle size from about 0.5 mm to about 2 mm (500 to 2000 microns) in diameter (or approximate dimension if not rounded), flux composition in some embodiments of the present disclosure range in average particle size from about 0.005 mm to about 0.10 mm (5 to 100 microns) in diameter. In some cases the average particle size ranges from about 0.01 mm to about 5 mm, or from about 0.05 mm to about 2 mm. In other cases the average particle size ranges from about 0.1 mm to about 1 mm in diameter, or from about 0.2 mm to about 0.6 mm in diameter.

A third factor relates to the intensity and positioning of the plasma 22 which may be formed in certain embodiments. As explained above, the flux composition 8 may be formulated to contain a plasma-generating agent 44 which, upon contact with the laser beam 20, can undergo ionization to form a plasma 22 capable of absorbing radiant energy of the laser beam 20. Increased absorption of laser energy by the plasma 22 tends to reduce direct (radiant) heating of the filler material 4 by the laser beam, and tends to correspondingly increase indirect heating via radiation to and conduction through the molten slag blanket 24. Thus, an amount of direct (radiant) heating may in some embodiments be controlled to a certain extent by including, or increasing the proportion of, at least one plasma-generating agent 44 in the flux composition 8. As explained in further detail below, plasma-generating agents 44 may include ionic compounds.

The degree of laser absorption by the plasma 22 may also be controlled to a certain extent by altering the position of the plasma 22. The position and shape of the plasma plume can be changed by projecting an inert gas, such as helium or argon, into the plasma 22. As shown in FIG. 2, projecting an inert gas 34 through an injection nozzle 32 into the plasma 22 can alter the amount of laser absorption (by the plasma) by pushing the plasma plume away from the laser beam 20. Consequently, in the embodiment of FIG. 2 the molten slag blanket 24 is subject to both direct (radiant) heating from the laser beam 22 and indirect heating from the offset plasma plume 22. Whereas in FIG. 2 the plasma plume is being displaced (from right to left) in the opposite direction to the motion of the laser beam 20, in other embodiments the plasma plume may be displaced (from left to right) in the same direction as the motion of the laser beam 20.

In some embodiments of the present invention, laser powder deposition as described above may be performed under an atmosphere containing greater than 10 ppm of oxygen. For example, some embodiments may be conducted in air without the use of an externally-applied inert gas to deposit reactive metals and alloys largely free of the chemical and mechanical imperfections described above. Other embodiments may be performed under an inert gas atmosphere such as helium, nitrogen or argon, or in the presence of a flowing inert gas.

In processes of the present disclosure the flux composition 8, the molten slag blanket 24, and the solid slag layer 16, 28 provide a number of functions that are beneficial to improve the chemical and mechanical properties of the resulting deposited alloy layer 14.

First, they function to shield both the region of the melt pool 12, 30 and the solidified (but still hot) alloy layer 14 from the atmosphere in the region downstream of the laser beam 10,20. The slag floats to the surface to separate the molten or hot metal from the atmosphere, and the flux composition 8 may be formulated to produce at least one shielding gas 26 as described above, thereby avoiding or minimizing the use of inert gases, sealed chambers and specialized process and trailing shields. In some embodiments requiring deep penetration and higher levels of heating, the flux composition 8 does not contain a shielding agent 18 such that the melt pool 12 (or the molten slag blanket 24 and the filler melt pool as shown in FIG. 2) are not exposed to a potentially-reactive shielding gas.

Second, the molten slag blanket 24 and the solid slag layer 16,28 act as an insulation layer that allows the deposited alloy layer 14 to cool slowly and evenly, thereby reducing residual stresses that can contribute to post weld cracking, and reheat or strain age cracking. Such slag blanketing over and adjacent to the deposited alloy layer 14 can further enhance heat conduction towards the support material 2 which in some embodiments can promote directional solidification to form elongated (uniaxial) grains 36 in the deposited alloy layer 14 (see FIG. 2).

Third, the molten slag blanket 24 and the solid slag layer 16,28 help to shape and support the melt pool 12,30 to keep it close to a desired height/width ratio (e.g., a ⅓ height/width ratio). This shape control and support further reduces solidification stresses that could otherwise be imparted to the deposited alloy layer 14.

Fourth, the molten slag blanket 24 and the solid slag layer 16,28 provide a cleaning effect for removing trace impurities that contribute to inferior properties. Such cleaning may include deoxidation of the powdered filler material 4. Because the flux composition 8 is in intimate contact with the filler material 4, it is especially effective in accomplishing this function.

Fifth, the molten slag blanket 24 and solid slag layer 16, 28 can serve as a heat source to transmit heat energy to the filler material 4 leading to melting and formation of the melt pool 12, 30. It may also provide an energy absorption and trapping function as described above to more effectively convert the laser beam 10, 20 into heat energy, thus facilitating a precise control of heat input to the filler material 4. In some embodiments the flux may contain exothermic agents that provide additional supplemental heating during the inventive processes.

Additionally, the flux composition 8 may be formulated to compensate for loss of volatilized or reacted elements during processing or to actively contribute elements to the deposit that are not otherwise provided by the reactive alloy 6. In some embodiments, additional elements may also be provided by injecting metallic particles 40 into the melt pool 12 by projecting them through an injection nozzle 38 using a gas jet 42 of an inert gas like helium, nitrogen or argon, as shown in FIG. 1.

The flux composition 8 is formulated to contain (i) a non-oxygenated vehicle and optionally at least one additional agent such as (ii) a plasma-generating agent, (iii) a shielding agent, (iv) a viscosity enhancer, (v) a scavenging agent, (vi) a vectoring agent, and (vii) an organic additive. As explained above, in some embodiments the flux composition 8 does not contain a shielding agent, such that the melt pool 12, 30 is not exposed to a potentially-reactive shielding gas (e.g., CO, CO₂).

Non-oxygenated vehicles include metal halides such as LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, GaBr₂, Ga₂Cl₄, GaCl₃, GaF₃, GaI₃, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, ClF CsI, BaCl₂, BaF₂, BaI₂, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, LaBr₃, LaCl₃, LaF₃, LaI₃, CeBr₃, CeCl₃, CeF₃, CeF₄, CeI₃, and mixtures thereof, as well as other non-oxygenated compounds that melt in the presence of a laser beam or plasma to form relatively low-density slag layers which float on the surface of the melt pool 12,30 and are capable of acting as gas barriers to protect the melt pool 12,30 from oxidation, nitridation and the like.

Plasma-generating agents may include ionic compounds such as Li₂O, Na₂O, K₂O, Cu₂O, Rb₂O, Cs₂O, BaO, LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, RbBr, RbCl, RbF, RbI, SrBr₂, SrCl₂, SrF₂, SrI₂, CsBr, CsCl, ClF CsI, BaCl₂, BaF₂, BaI₂, and mixtures thereof, as well as other compounds that are readily ionized by a laser beam to form a plasma.

Shielding agents include metal carbonates such as Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(OH)₂, and mixtures thereof, as well as other compounds which decompose in the presence of heat or laser energy to from shielding and/or reducing gases (e.g., CO, CO₂, H₂).

Viscosity enhancers include metal oxides such as B₂O₃, B₆O, Al₂O₃, SiO₂, Sc₂O₃, TiO₂, V₂O₅, Cr₂O₃, CrO₂, Mn₂O₃, Fe2O3, CoO, CO₃O₄, NiO, Ni₂O₃, Cu₂O, CuO, ZnO, Ga₂O₃, GeO₂, Rb₂O, SrO, Y₂O₃, ZrO₂, NiO, NiO₂, Ni₂O₅, MoO₃, MoO₂, RuO₂, Rh₂O₃, RhO₂, PdO, CdO, In₂O₃, SnO, SnO₂, Sb₂O₃, TeO₂, TeO₃, Cs₂O, HfO₂, Ta₂O₅, WO₃, ReO₃, Re₂O₇, PtO₂, Au₂O₃, La₂O₃, CeO₂, Ce₂O₃, and mixtures thereof, as well as other compounds that increase viscosity of slag layers.

Scavenging agents include metal oxides, such as CaO, FeO, MgO, MnO, MnO₂, NbO, NbO₂, Nb₂O₅, TiO₂, ZrO₂, metal halides, such as MgCl₂, NaCl, KCl, and other agents known to react under high temperature conditions with detrimental elements such as sulfur and phosphorous (in some alloys systems) and other undesirable elemental impurities to form low-density products that “float” into a resulting slag layer. In some embodiments the flux composition 8 can include a scavenging agent which reacts upon heating to remove nitrogen, hydrogen or both, from the melt pool 12, 30. Such agents are selected to include elements which, when combined with nitrogen and/or hydrogen in an ionized state, react to form low-density nitrogen-containing and/or hydrogen-containing compounds that float into the molten slag layer and ultimately become trapped in the solid slag layer 16,28.

Vectoring agents include metal halides, oxides, silicates and carbonates such as Li₂NiBr₄, LiAlCl₄, LiGaCl₄, Li₂PdCl₄, Na₃AlF₆, NaVO₃, Na₂MoO₄, NaAlCl₄, Na₂PdCl₄, AlF₃, K₂RuCl₅, K₂CrO₄, K₂Cr2O₇, K₂NiF₆, K₂TiF₆, K₂ZrF₆, K₂PdBr₄, K₂PdCl₄, CaSiO₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, GaBr₃, Ga₂Cl₄, GaCl₃, GaF₃, GaI₃, GaBr₂, GeBr₂, GeI₂, GeI₄, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, BaMnO₄, BaCoF₄, BaNiF₄, TaCl₅, TaF₅, Al₂O₃, SiO₂, V₂O₅, Cr₂O₃, CrO₂, Mn₂O₃, Fe2O3, CoO, Co₃O₄, NiO, Ni₂O₃, Cu₂O, CuO, Ga₂O₃, GeO₂, Rb₂O, ZrO₂, NiO, NiO₂, Ni₂O₅, MoO₃, MoO₂, RuO₂, PdO, Ta₂O₅, Cr₂(CO₃)₃, MnCO₃, CoCO₃, NiCO₃, CuCO₃, NaAl(CO₃)(OH)₂, mixtures thereof, and other metal-containing compounds and materials capable of supplementing molten alloys with elements.

Organic additives may also be added and include high-molecular weight hydrocarbons (e.g., beeswax, paraffin), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydro-abietylamine), amines (e.g., triethanolamine), alcohols (e.g., high polyglycols, glycerols), natural and synthetic resins (e.g., polyol esters of fatty acids), mixtures thereof, and other organic compounds capable of fulfilling at least one additive function.

In some embodiments the flux composition contains a metal halide but does not contain an oxygen-containing compound. In other embodiments the flux composition contains a metal halide and a plasma-generating agent but does not contain an oxygen-containing compound. In other embodiments the flux composition contains a metal halide, a plasma-generating agent, and a metal carbonate, but does not contain a metal oxide. In still other embodiments the flux composition contains a metal halide, a plasma-generating agent, a metal carbonate and a viscosity enhancer.

In one embodiment the flux composition contains at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr₂, CuCl₂, CuF₂, ZnF₂, ZnBr₂, ZnCl₂, ZnI₂, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, BaCl₂, BaF₂, BaI₂, TaF₅, WCl₄ and WCl₆. In another case the flux composition includes at least one of these compounds but excludes an oxygen-containing compound.

In another embodiment the flux composition contains: (i) at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr₂, CuCl₂, CuF₂, ZnF₂, ZnBr₂, ZnCl₂, ZnI₂, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, BaCl₂, BaF₂, BaI₂, TaF₅, WCl₄ and WCl₆; and (ii) at least one selected from the group consisting of Li₂O, Na₂O, K₂O, Cu₂O, Rb₂O, Cs₂O and BaO.

In another embodiment the flux composition contains: (i) at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr₂, CuCl₂, CuF₂, ZnF₂, ZnBr₂, ZnCl₂, ZnI₂, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, BaCl₂, BaF₂, BaI₂, TaF₅, WCl₄ and WCl₆; and (ii) at least one selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(OH)₂.

In another embodiment the flux composition contains: (i) at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr₂, CuCl₂, CuF₂, ZnF₂, ZnBr₂, ZnCl₂, ZnI₂, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, BaCl₂, BaF₂, BaI₂, TaF₅, WCl₄ and WCl₆; (ii) at least one selected from the group consisting of B₂O₃, Al₂O₃, SiO₂, TiO₂, V₂O₅, Cr₂O₃, Mn₂O₃, Fe2O3, CoO, Co₃O₄, NiO, Ni₂O₃, Cu₂O, CuO, ZnO, ZrO₂, NiO, NiO₂, Ni₂O₅, MoO₃, MoO₂, RuO₂, Rh₂O₃, RhO₂, PdO, HfO₂, Ta₂O₅, WO₃, La₂O₃, CeO₂ and Ce₂O₃.

In another embodiment the flux composition contains: (i) at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr₂, CuCl₂, CuF₂, ZnF₂, ZnBr₂, ZnCl₂, ZnI₂, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, BaCl₂, BaF₂, BaI₂, TaF₅, WCl₄ and WCl₆; and (ii) at least one selected from the group consisting of Li₂NiBr₄, LiAlCl₄, LiGaCl₄, Li₂PdCl₄, Na₃AlF₆, NaVO₃, Na₂MoO₄, NaAlCl₄, Na₂PdCl₄, K₂RuCl₅, K₂CrO₄, K₂Cr2O₇, K₂NiF₆, K₂TiF₆, K₂ZrF₆, K₂PdBr₄, K₂PdCl₄, CaSiO₃, BaMnO₄, BaCoF₄ and BaNiF₄.

In some embodiments the flux composition contains at least two metal halides selected from the group consisting of CaF₂, LiF, CaCl, KCl, NaCl and LiCl. Other flux compositions contain at least two of these metal halides but does not contain an oxygen-containing compound. In some embodiments the flux composition contains a metal halide and at least two metal carbonates. In other cases the flux composition contains a metal halide and at least one high-temperature oxide selected from Sc₂O₃, Cr₂O₃, Y₂O₃, ZrO₂, HfO₂, La₂O₃, Ce₂O₃ and CeO₂. In some embodiments the flux composition contains a metal halide and at least 7.5 percent by weight of a high-temperature oxide such as zirconia, relative to a total weight of the flux composition.

The filler material contains a reactive metal such as aluminum, magnesium, titanium and zirconium. In some embodiments the filler material contains at least 25 percent by weight of at least one reactive metal. For example, the filler material may contain at least 25 percent by weight of titanium. In another example the filler material may contain at least 25 percent by weight of titanium and at least 25 percent by weight of aluminum. In still another example the filler material may contain at least 25 percent by weight of a mixture of titanium and aluminum. In some embodiments the filler material contains at least 50 percent by weight of at least one reactive metal. In other embodiments the filler material contains at least 75 percent by weight of at least one reactive metal. In some cases the filler material consists essentially of at least one reactive metal, meaning that the filler material consists of the at least one reactive metal and optionally small amounts (e.g., less than 2 percent by weight) of other metal impurities typically contained in commercial sources of the reactive metal. All percents by weight are relative to a total weight of the filler material.

In methods of the presence disclosure the laser beam 10,20 may a laser beam such as a continuous laser beam, a pulsed laser beam, one or more circular laser beams, a scanned laser beam (scanned one, two or three dimensionally), an integrated laser beam, a diode laser beam, or other laser configurations. As explained above, laser sources may include a “green” Nd:YAG laser (503 nm), a ytterbium fiber laser (1.06 μm) and/or a CO₂ laser (10.6 μm). Use of low-power-enabled laser sources such as solid-state lasers (e.g., Nd:YAG lasers) and fiber lasers (e.g., Ytterbium fiber lasers) can be useful for reducing the degree of direct radiant heating of the filler material 4 and the melt pool 12,30. The intensity of the laser beam 10, 20 may also be reduced by controlling the power, focusing and dimensions of the scanning area, and also by controlling the traversal speed of the laser beam. The laser beam 10, 20 may be a diode laser beam having a generally rectangular cross-sectional shape. The rectangular shape may be particularly advantageous for embodiments having a relatively large area to be clad, such as for repairing the tip of a turbine blade.

In some embodiments the flux composition may contain at least one optically transparent substance which is at least partially transmissive to the wavelength of the laser beam 10, 20. Materials transmissive to CO₂ laser radiation include, for example, borosilicate glass, phosphate glass (Pb+Fe), phosphate glass (Na+Al), silica, sapphire, magnesium fluoride and calcium fluoride, to name a few.

The processes illustrated in FIG. 1 and FIG. 2 can be adapted to accomplish a variety of different tasks involving the melting and re-solidification of reactive metals and alloys. Such tasks include manufacture and repair processes involving laser powder deposition and cladding of reactive metals, additive manufacturing of three-dimensional objects containing reactive metals, laser joining (welding) of objects containing reactive metals, surface modification of objects containing reactive metals, as well as other melting/solidification tasks.

Some embodiments, for example, involve laser powder deposition of reactive metals or alloys to produce cladding layers or cast objects containing the reactive metals. To accomplish laser cladding, the support material 2 is metallic substrate such as, for example, a titanium alloy substrate or a superalloy substrate. Alloys containing mixtures of reactive metals with another elements may serve as one or both of the support material 2 and the reactive alloy 6. One example of such an alloy is the intermetallic alloy known as NITINOL (nickel titanium naval ordinance laboratory) which is a so-called “shape memory” alloy containing an approximately 1:1 mixture of nickel and titanium.

To accomplish laser casting of a reactive metal or alloy, the filler material 4 may be deposited onto the surface of a fugitive support material 2, and a laser cladding process of the present disclosure is carried out to produce the deposited alloy layer 14, which is later separated from the fugitive support material 2 to produce an object containing a reactive metal. “Fugitive” means removable after formation of the deposited alloy layer 14, for example, by direct (physical) removal, by a mechanical process, by draining, by fluid flushing, by chemical leaching and/or by any other process capable of separating the fugitive support material 2 from the deposited alloy layer 14. Any high-temperature material or structure capable of providing support and then being removable after the formation of the deposited alloy layer 4 may serve as the fugitive support material 2. In some embodiments the fugitive support material 2 may be in the form of a refractory container or bed of at least one material selected from a metal, a metallic powder, a metal oxide powder, a ceramic powder and a powdered flux material.

Laser joining and welding of reactive-metal-containing substrates may also be performed by deposited a filler material 4 in a groove or joint formed by juxtaposing two substrates 2, then depositing the flux composition 8 onto the surface of the filler material 4, followed by laser powder deposition of described above. Surface modification of reactive metals and alloys may also be performed by adding or injecting hardening particles (e.g., oxides, nitrides, carbides) in the melt pool 12, such that the resulting alloy 14 exhibits increased mechanical strength or corrosion resistance. As shown in FIG. 1, such injection of hardening particles may occur by propelling the hardening particles 42 into the melt pool 12 within a gas jet 42 through an injection nozzle 38.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method, comprising laser melting a titanium alloy filler material in the presence of a flux composition under an atmosphere comprising greater than 10 ppm of oxygen, to form a titanium alloy cladding bonded to a surface of a titanium-containing component.

2. The method of claim 1, wherein:
the flux composition comprises at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, GaBr₂, Ga₂Cl₄, GaCl₃, GaF₃, GaI₃, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, ClF CsI, BaCl₂, BaF₂, BaI₂, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, LaBr₃, LaCl₃, LaF₃, LaI₃, CeBr₃, CeCl₃, CeF₃, CeF₄, CeI₃; and
the flux composition is in the form of a layer situated on top of the titanium alloy filler, said layer having a thickness ranging from about 3 mm to about 25 mm.

3. The method of claim 2, wherein the flux composition further comprises at least one selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(OH)₂.

4. The method of claim 2, wherein the flux composition further comprises at least one selected from the group consisting of Sc₂O₃, Cr₂O₃, Y₂O₃, ZrO₂, HfO₂, La₂O₃, Ce₂O₃ and CeO₂.

5. The method of claim 1, wherein the titanium alloy cladding is a metal alloy comprising nickel and titanium.

6. A process, comprising:
applying a laser beam to a flux composition that covers a powdered filler material, such that the laser beam simultaneously melts the flux composition and the powdered filler material to form a melt pool; and
allowing the melt pool to cool and solidify to form a resulting alloy layer covered by a slag layer,
wherein:
the flux composition comprises a metal halide;
the flux composition does not comprise a metal oxide; and
the powdered filler material comprises a reactive metal.

7. The process of claim 6, wherein the reactive metal is selected from the group consisting of aluminum, magnesium, titanium and zirconium.

8. The process of claim 6, occurring under an atmosphere comprising greater than 10 ppm of oxygen.

9. The process of claim 6, wherein the flux composition comprises at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, GaBr₂, Ga₂Cl₄, GaCl₃, GaF₃, GaI₃, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, ClF CsI, BaCl₂, BaF₂, BaI₂, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, LaBr₃, LaCl₃, LaF₃, LaI₃, CeBr₃, CeCl₃, CeF₃, CeF₄, CeI₃.

10. The process of claim 6, wherein:
the process does not occur under an inert gas atmosphere; and
the flux composition comprises at least one selected from the group consisting of CaF₂, LiF, CaCl, KCl, NaCl and LiCl.

11. The process of claim 6. wherein the flux composition comprises at least one selected from the group consisting of Li₂NiBr₄, LiAlCl₄, LiGaCl₄, Li₂PdCl₄, Na₃AlF₆, NaAlCl₄, Na₂PdCl₄, AlF₃, K₂RuCl₅, K₂NiF₆, K₂TiF₆, K₂ZrF₆, K₂PdBr₄, K₂PdCl₄, BaCoF₄ and BaNiF₄.

12. The process of claim 6, wherein the flux composition is in the form of a layer situated on top of the powdered filler material, said layer having a thickness ranging from about 3 mm to about 25 mm.

13. The process of claim 6, further comprising feeding or injecting a supplemental filler material into the melt pool, said supplemental filler material comprising elements that complement the powdered filler material such that a composition of the resulting alloy layer is different than a composition of the powdered filler material.

14. The process of claim 6, further comprising feeding or injecting particles into the melt pool, said particles comprising at least one selected from the group consisting of a metal oxide, a metal carbide and a metal nitride, such that the resulting alloy layer is a dispersion strengthened alloy layer.

15. A process, comprising:
(i) heating a flux composition with a laser beam such that the flux composition reacts upon contact with the laser beam to form a plasma and a shielding gas;
(ii) controlling an amount of energy applied to the flux composition to convert the flux composition into a molten slag blanket in the presence of the shielding gas without completely melting a powdered filler material situated below the flux composition, such that the molten slag blanket then heats and melts the powdered filler material by thermal conduction in the presence of the shielding gas to form a filler melt pool covered by the molten slag blanket;
(iii) allowing the molten slag blanket to cool and at least partially solidify into a solid slag layer covering the filler melt pool; and
(iv) allowing the filler melt pool to cool and solidify into a resulting alloy layer covered by the solid slag layer;
wherein the powdered filler material comprises at least 50 percent by weight of a reactive metal selected from the group consisting of aluminum, magnesium, titanium and zirconium, relative to a total weight of the powdered filler material.

16. The process of claim 15, wherein the flux composition comprises:
at least one selected from the group consisting of LiF, LiCl, LiBr, LiI, NaF, NaCl, NaBr, MgF₂, MgCl₂, MgBr₂, AlF₃, KCl, KF, KBr, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, GaBr₂, Ga₂Cl₄, GaCl₃, GaF₃, GaI₃, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, ClF CsI, BaCl₂, BaF₂, BaI₂, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, LaBr₃, LaCl₃, LaF₃, LaI₃, CeBr₃, CeCl₃, CeF₃, CeF₄, CeI₃; and
at least one selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(CO₃)₂.

17. The process of claim 15, wherein the flux composition is in the form of a layer situated on top of the powdered filler material, said layer having a thickness ranging from about 3 mm to about 25 mm.

18. The process of claim 15, wherein an average particle size of the flux composition ranges from about 0.005 mm to about 5 mm in diameter.

19. The process of claim 15, further comprising projecting an inert gas through an injection nozzle into the plasma such that a plume of the plasma is directed away from the laser beam.

20. The process of claim 15, wherein the process does not occur under an inert gas atmosphere.
